(19) United States
(12) Patent Application Publication
(10) Pub. No.: US 2003/0083162 A1
(43) Pub. Date: May 1, 2003

(54) Rear derailleur of a bicycle

(75) Inventors: Ming-Chih Tsai, Taipei (TW); Jimmy Tsai, FanYuan City (TW)

Correspondence Address: DOUGHERTY & TROXELL, SUITE 1404, 5205 LEESBURG PIKE, FALLS CHURCH, VA, 22041, US

(73) Assignee: SunRace Roots Enterprise Co., Ltd.

(21) Appl. No.: 09/983,849

(22) Filed: Oct. 26, 2001

(51) Int. Cl. F16H 9/00; F16H 59/00; F16H 61/00; F16H 63/00

(52) U.S. Cl. 474/82; 474/80

(57) ABSTRACT

A device related to the rear derailleur of a bicycle. It includes a fixed member which is fixed on the rear fork of the bicycle with a fixed screw, a shock absorbing member which is fixed on the fixed member to reduce the shock when rider changing the gear ratio, a outer linkage and a inner linkage, with parallel moving mechanism formed by a parallelogram set, to tug the movable member in order to fulfill the purpose of changing speed; a guiding pulley/chain member which comprises a upper guiding pulley, a lower guiding pulley and a guiding chain, while said upper guiding pulley is connected to the upper part of said guiding chain and said lower guiding pulley is connected to the lower part of said guiding chain. Furthermore, the said guiding pulley and chain member is connected to the movable member via a rotating set. The fixed member, the shock absorbing member, the outer linkage, the movable member and the guiding pulley/chain member are all made of plastic and there is a metal washer on one end of the outer linkage to provide protect function between the metal length micro-adjusting screw and the outer linkage.

### FIELD OF THE INVENTION

The present invention relates to a rear derailleur of a bicycle. Especially, its main structure is made of plastic and it will reduce shock of the rear derailleur.

### BACKGROUND OF THE INVENTION

Being developed for many years, a bicycle with 4 or 5 gear ratio in the earlier days now is advancing to be a 12 or more gear ratio one, therefore, the rear derailleur is playing a more and more important role while the operation of switching gear is performed. So, how to longer product life of a rear derailleur, how to reduce the shock while switching gear ratio, how to reduce the weight of bicycle and how to make people feel comfortable when riding a bicycle are the critical points when developing a derailleur.

In many years, the structure of the derailleur taught in prior art is made by metal material which not only hard to process but heavier, and the cost is also high. And being used for a while, the anti-rustic cover coating of the rear derailleur is getting to peel off, which make the inner side of metal material to get rustic and the operation of switching gear become uneasy. Still worse, it reduces the time of usage of the rear derailleur. More over, in prior art, the derailleur has no shock absorbing finction for a bicycle. It generates shock when rider switching gear, and operation in such manner for a while will cause some problems like screw loose, switching position out of place and chain loose, which eventually make the rear derailleur out of function.

### SUMMARY OF THE INVENTION

The present invention provides a rear derailleur installed on the rear fork end of a bicycle. The main material of said rear derailleur is made of plastic to avoid rustic problem, other advantages including reducing the weight of a bicycle, increasing the time of usage, and reducing the manufacture cost.

In one object of the present invention is that the said invention provides a rear derailleur which can be manufactured by plastic injection modeling technology.

In another object of the present invention is that the said invention provides a rear derailleur which will reduce the shock; when rider switching the gear ratio; to avoid the screw loose and uncomfortable gear switching problems.

To fulfill the above objects, the present invention of a rear derailleur comprises a fixed member which has a steel cable set and is fixed on the rear fork of the bicycle with a fixed screw, a moveable member which is a curve-shaped structure with the first connecting end and the second connecting end, a shock absorbing member which is fixed on the fixed member to reduce the shock when changing speed, a outer linkage which has a cable guiding member to guide a speed changing cable and is with one end connected to the said fixed member by the first pin and is with another end connected to the first end of the said moveable member by the third pin, a inner linkage with one end connected to the said fixed member by the second pin and with another end connected to the first end of the said moveable member by the forth pin, a guiding pulley/chain member which is consistent of a upper guiding pulley, a lower guiding pulley and a guiding chain, wherein the said upper guiding pulley is connected to the upper part of said guiding chain and said lower guiding pulley is connected to the lower part of said guiding chain and the said guiding pulley/chain member is connected to the said moveable member by a rotating pin; a length micro-adjusting screw which is through the said fixed member to adjust the position of the said outer linkage, a altitude micro-adjusting screw which is through the said fixed member to adjust the said inner linkage, wherein the said fixed member, the said shock absorbing member, the said steel cable set, the said outer linkage, the said cable guiding member, the said moveable member, the said guiding pulley/chain member are all made of plastic. Further, there is a metal washer on the said outer linkage near the said length micro-adjusting screw to provide the protection function between the said length micro-adjusting screw and the said outer linkage. The first pin, the second pin, the third pin and the forth pin form the parallelogram which will provide the parallel moving mechanism to tug the said movable member in order to fulfill the purpose of changing speed. The present invention of a rear derailleur can be manufactured by plastic injection modeling technology and no need extra manufacturing effort.

The appended drawings will provide further illustration of the present invention, together with the description, serve to explain the principles of the invention.

### BRIEF DESCRIPTION OF THE DRAWINGS

FIG. 1 shows the face view of a preferred embodiment of the present invention.

FIG. 2 shows the side view of a preferred embodiment of the present invention.

FIG. 3 shows the operational diagram of a preferred embodiment of the present invention.

### DETAILED DESCRIPTION OF THE PRESENT INVENTION

The present invention provides a rear derailleur. The main material of said rear derailleur is made of plastic so as to avoid rustic problem, to reduce weight, to increase the time of usage, and to reduce the manufacture cost.

The said rear derailleur can be manufactured by plastic injection modeling technology and will reduce the shock; when rider switching the gear ratio; to avoid the screw loose and uncomfortable gear switching problems.

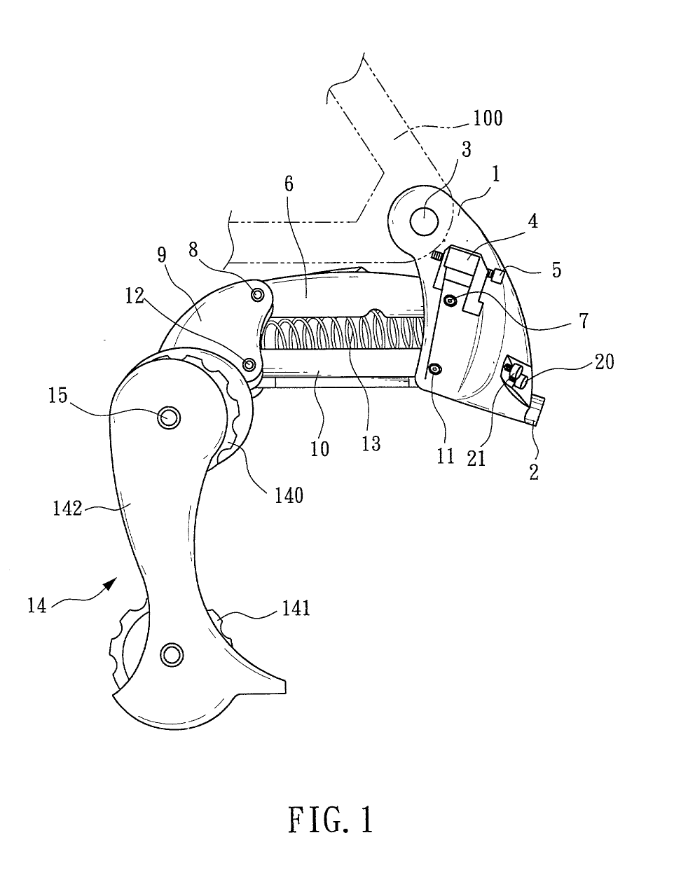

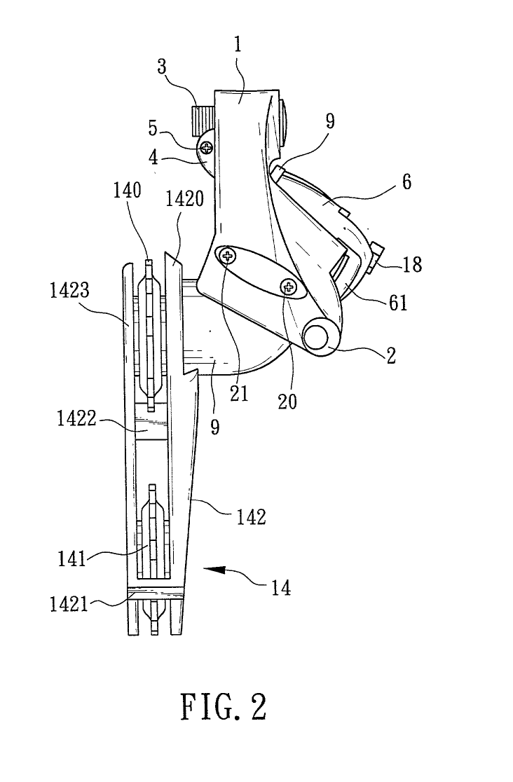

As shown in FIG. 1 and FIG. 2, the rear derailleur of a bicycle comprises a fixed member 1, a steel cable set 2, a shock absorbing member 4, a outer linkage 6, a cable guiding member 61, a inner linkage 10, a curve-shaped moveable member with a first connecting end and a second connecting end and a guiding pulley/chain member 14. Wherein, the fixed member 1, the steel cable set 2, the shock-absorbing member 4, the outer linkage 6, the cable guiding member 61, the inner linkage and the guiding pulley/chain member 14 are made of plastic.

The fixed member 1 has a steel cable set 2 and is fixed on the rear fork of a bicycle by a fix screw 3; the shock absorbing member is on the fixed member 1 and is fixed on the rear fork 100 by a narrow screw 5. Since the narrow screw 5 and the fix screw 3 is connected vertically, the rear derailleur is not easy to shake when the operation of gear switching is performed, and because the shock absorbing member 4 is made of plastic, which will absorb the shock generated by the narrow screw 5 when the operation of gear switching is performed; a outer linkage 6 with a cable guiding member 61 to guide the steel gear switching cable, one end of the said outer linkage 6 is connected to the fixed member 1 by the first pin 7, another end of the said outer linkage 6 is connected to the first end of the moveable member 9 by the third pin 8; a inner linkage 10 with one end connected to the fixed member 1 by the second pin 11, another end of the said inner linkage 10 is connected to the first end of the moveable member 9 by the forth pin 12, also, there is a return spring linking the first pin and the forth pin to provide the returning fuinction; a guiding pulley/chain member 14 which is consistent of a upper guiding pulley 140, a lower guiding pulley 141 and a guiding chain member 142 and the said upper guiding pulley 140 is connected to the upper part of said guiding chain member 142 and said lower guiding pulley 141 is connected to the lower part of said guiding chain member 142 and the said guiding pulley/chain member 14 is connected to the second end of said moveable member 9 by a rotating pin 15; the said rotating pin 15 has a return mechanism ( not shown in the drawings) which provides the returning force used by the said guiding pulley/chain member 14, the said guiding chain member 142 is consistent of the inner chain guiding board 1420, the linking board 1421, the enhanced bone 1422 and the outer chain guiding board 1423, a chain (not shown in the drawings) is placed in the said guiding pulley/chain member 14, and the said chain will be moved in and out by utilizing-the inner chain guiding board 1420 and the outer chain guiding board 1423 to achieve the purpose of gear switching, and the function of the linking board 1421 is to prevent the said chain from coming off from the guiding pulley/chain member 14, the enhanced bone 1422 will enhance the linking strength between the inner chain guiding board 1420 and the outer chain guiding board 1423.

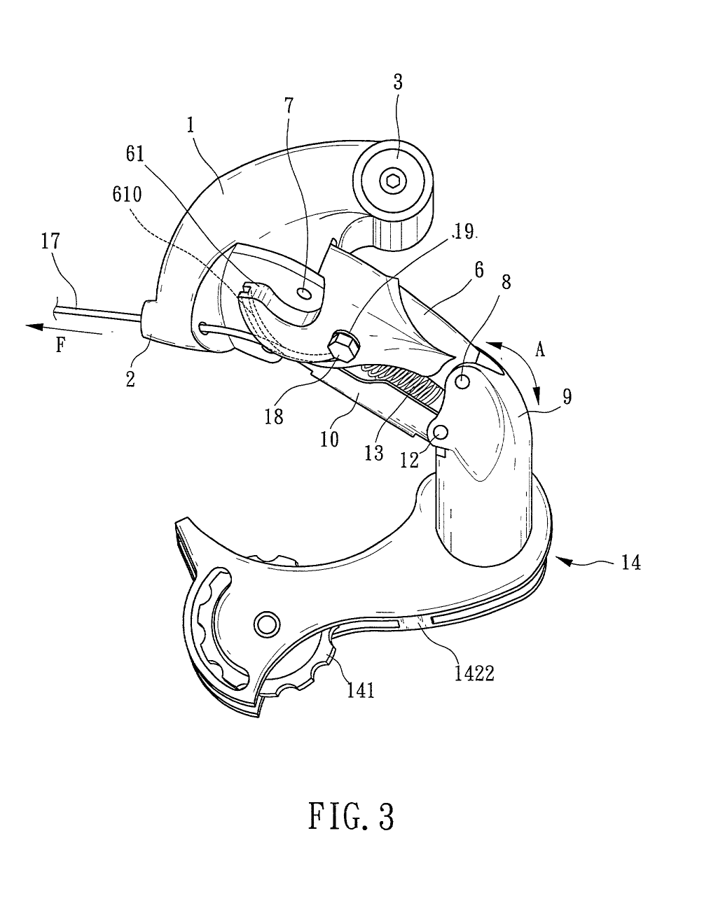

As shown in FIG. 3, the steel gear switching cable 17 goes through the steel cable set 2 and the cable guiding slot 610 and goes along with the extension of the outer linkage 6; the curve-shaped cable guiding member 61; and fixed firmly by a steel cable screw 18 and a washer 19, since the cable guiding member 61 is made of plastic and is with excellent lubrication, which enable the steel gear switching cable 17 not easy to wear out and the operation of gear switching more smooth. When a force of F direction is applied to the steel gear switching cable 17; with the parallel moving mechanism provided by the parallelogram which formed by the outer linkage 6,the inner linkage 10, the first pin 7, the third pin 8, the second pin 11 and the forth pin 12; the steel gear switching cable 17 will tug the moveable member 9 and the guiding pulley/chain member 14 to move toward along with direction A to fulfill the purpose of changing the gear ratio. When the length micro-adjusting screw 20 (as shown in FIG. 2) goes through the fixed member 1, it will adjust the in and out moving position of the outer linkage 6, and, when the altitude micro-adjusting screw 21 (as shown in FIG. 2) goes through the fixed member 1, it will adjust the up and down moving position of the inner linkage 10, therefore, the start and stop position of the rear derailleur of a bicycle will be determined, which make it possible that the rear derailleur can be used in any kind of bicycle. Also, there is a metal washer (not shown in the drawings) placed on the outer linkage 6 near one end of the length micro-adjusting screw 20 to provide the protection finction between the outer linkage 6 and the length micro-adjusting screw 20 and to prevent the outer linkage 6 from damage when operated.

The rear derailleur of the present invention, wherein the fixed member, the steel cable set, the shock absorbing member, the outer linkage, the cable guiding member, the moveable member and the guiding pulley/chain member are all made of plastic and can be manufactured by plastic injection modeling technology with no extra manufacture effort and with lower manufacture cost. The cable guiding member is made of plastic and is with excellent lubrication, which enable the steel cable not easy to wear out during the gear switching and the operation of gear switching more easy. More over, the shock absorbing member is also made of plastic which will absorb the shock generated by the narrow screw of the rear derailleur when rider switching the gear, which will increase the precision of the gear switching but reduce the possibility of adjustment. And, because the major structure of the rear derailleur is made of plastic, it extremely reduce the total weight of a bicycle, which make the bicycle user more easy to use the bicycle. Comparing with the metal rear derailleur in the prior art, the present invention does not need complex manufacture process, no rustic problem, and can be used in many kinds of weather, it has longer product life and many other advantages.

While the present invention has been shown and described with reference to a preferred embodiment thereof, and in terms of the illustrative drawings, it should be not considered as limited thereby, Various possible modification, omission, and alterations could be conceived of by one skilled in the art to the form and the content of any particular embodiment, without departing from the scope and the sprit of the present invention.

The invention is disclosed and is intended to be limited only the scope of the appended claims and its equivalent area.

What is claimed is:

1. A rear derailleur of a bicycle comprises:
a fixed member which has a steel cable set and is fixed on the rear fork of the bicycle with a fixed screw;
a shock absorbing member which is fixed on the fixed member to reduce the shock when rider changing the gear ratio;
a moveable member which is a curve-shaped structure with the first connecting end and the second connecting end;
an outer linkage which has a cable guiding member to guide a speed changing cable and is with one end connected to the said fixed member by the first pin, another end of the said outer linkage is connected to the first end of the said moveable member by the third pin;
an inner linkage with one end connected to the said fixed member by the second pin and with another end connected to the first end of the said moveable member by the forth pin;
a guiding pulley/chain member which is consistent of a upper guiding pulley, a lower guiding pulley and a guiding chain and the said upper guiding pulley is connected to the upper part of said guiding chain and said lower guiding pulley is connected to the lower part of said guiding chain and the said guiding pulley/chain member is connected to the said moveable member by a rotating pin;
wherein, the said shock absorbing member, the said outer linkage are all made of plastic. Further, there is a metal washer on the said outer linkage near the said length micro-adjusting screw to provide the protection function between the said length micro-adjusting screw and the said outer linkage and to prevent the outer linkage from damage.

2. The rear derailleur of a bicycle of claim 1, wherein a length micro-adjusting screw is through the fixed member to adjust the position of the outer linkage.

3. The rear derailleur of a bicycle of claim 1, wherein an altitude micro-adjusting screw is through the fixed member to adjust the position of the inner linkage.

4. The rear derailleur of a bicycle of claim 1, wherein the fixed member, the steel cable set, the moveable member, the guiding pulley/chain member are all made of plastic

5. The rear derailleur of a bicycle of claim 1, wherein the outer linkage has a cable guiding member to guide a steel speed changing cable, the said outer linkage is also made of plastic.

6. The rear derailleur of a bicycle of claim 1, wherein the first pin, the second pin, the third pin and the forth pin form the parallelogram which will provide the parallel moving mechanism to tug the said movable member to fulfill the purpose of changing speed.

7. The rear derailleur of a bicycle of claim 1, wherein the shock absorbing member is fixed on the rear fork of a bicycle by a narrow screw.

8. The rear derailleur of a bicycle of claim 5, wherein the cable guiding member is a curve-shape extension of the outer linkage.

9. The rear derailleur of a bicycle of claim 1, wherein the cable guiding member has a cable guiding slot, the steel guiding cable is through the said cable guiding slot and extend along with the said cable guiding member and is fixed by a steel cable screw and a washer.

10. The rear derailleur of a bicycle of claim 1, wherein the cable guiding member is consistent of a inner cable guiding board, a linking board, a enhanced bone and a outer cable guiding board.

11. The rear derailleur of a bicycle of claim 1, wherein the first pin is connected to the forth pin through a return spring.

12. The rear derailleur of a bicycle of claim 1, wherein the rotating pin has a returning mechanism, which provide the returning force used by the guiding pulley/chain member.

13. The rear derailleur of a bicycle of claim 12, wherein the returning mechanism can be a return spring.
